(19) United States
(12) Patent Application Publication
(10) Pub. No.: US 2011/0126228 A1
(43) Pub. Date: May 26, 2011

(54) MEDIA DISPLAYING SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/729,180

(22) Filed: Mar. 22, 2010

(30) Foreign Application Priority Data
Nov. 20, 2009 (CN) 200910310104.1

(51) Int. Cl. H04N 7/025

(52) U.S. Cl. 725/34

(57) ABSTRACT

A media displaying system includes a displaying unit, a time-of-flight (TOF) camera, and a processing unit. The TOF camera captures an image of an audience, and obtains distance data between a number of points of the audience and the TOF camera. The processing unit builds a three dimension (3D) model of the audience according to the image of the audience and the distance data between the points of the audience and the TOF camera, and obtains demographic information of the audience according to the 3D model of the audience. The processing unit further selects media content according to the demographic information about the audience. The displaying unit displays the selected media content by a displaying unit.

### BACKGROUND

1. Technical Field

The present disclosure relates to a media displaying system and a media displaying method.

2. Description of Related Art

Outdoor media, such as electronic billboards may advertise various goods to consumers who view the electronic billboards. Sometimes, operators need to obtain data from the outdoor media remotely, such as whether the acoustic and visual effects of the outdoor media attract people, and differences between attitudes toward the media contents from people from different demographics.

### BRIEF DESCRIPTION OF THE DRAWINGS

FIG. 1 is a schematic block diagram of a first embodiment of a media displaying system, the media displaying system includes a storage system.

FIG. 2 is a schematic block diagram of the storage system of FIG. 1, the storage system includes an information determining module and a storing module.

FIG. 3 is a schematic block diagram of the information determining module of FIG. 2.

FIG. 4 is a schematic block diagram of the storing module of FIG. 2.

FIG. 5 is a schematic block diagram of a second embodiment of a media displaying system.

FIG. 6 is a flowchart of an exemplary embodiment of a media displaying method.

### DETAILED DESCRIPTION

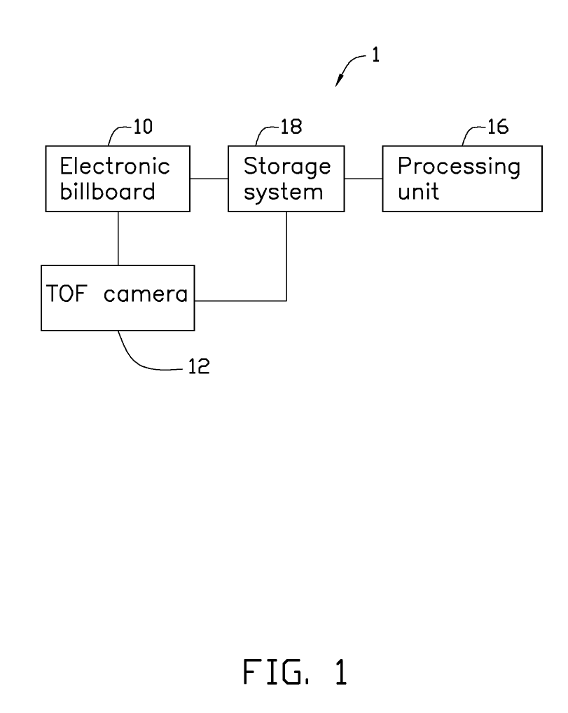

Referring to FIG. 1, a first embodiment of a media displaying system 1 includes a displaying unit, such as an electronic billboard 10, a time-of-flight (TOF) camera 12, a processing unit 16, and a storage system 18. The media playing system 1 can change media contents displayed on the displaying unit 10 according to the demographics of an audience.

The TOF camera 12 is disposed on the electronic billboard 10 to capture a plurality of audience images. Audience images are images of the one or more people who are viewing the electronic billboard 10. The TOF camera 12 is a camera system that creates distance data between a plurality of points of the audience and the TOF camera 12. When the TOF camera 12 shoots the audience, the TOF camera 12 sends electrical signals to the audience. The electrical signals would return to the TOF camera 12 when the electrical signals meet a body, such as a nose of the audience. As a result, the distance data can be obtained according to time differences between sending and receiving the electrical signals of the TOF camera 12.

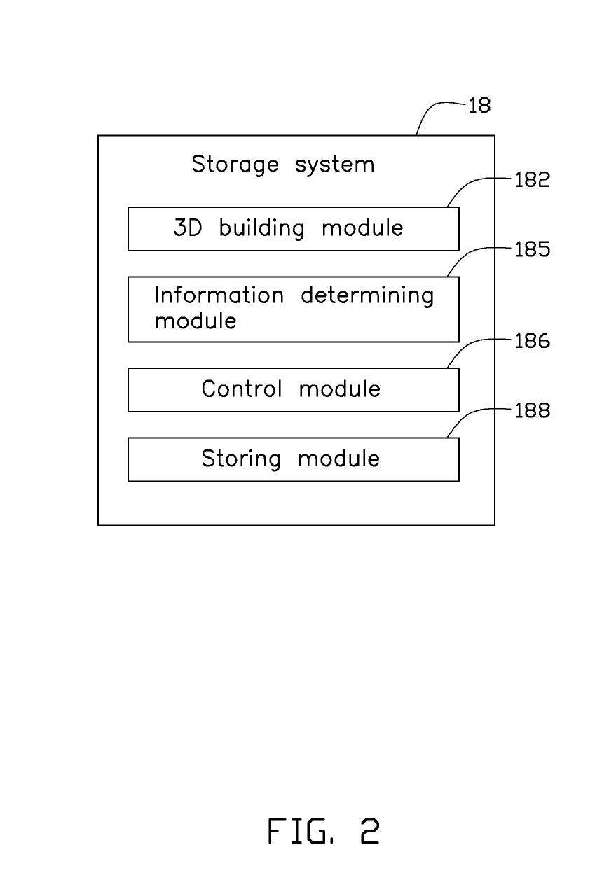

Referring to FIG. 2, the storage system 18 includes a three dimension (3D) building module 182, an information determining module 185, a control module 186, and a storing module 188. The 3D building module 182, the information determining module 185, and the control module 186 may include a plurality of computerized instructions executed by the processing unit 16.

The 3D model building module 182 builds a 3D model of the audience according to the image of the audience who is viewing the electronic billboard 10 and the distance data between every point of the audience and the TOF camera 12. In the embodiment, according to the distance data between every point of the audience and the TOF camera 12, every point of the audience has coordinates relative to the TOF camera 12. The 3D model building module 182 can obtain a curved surface according to the coordinates of every point and the image. The curved surface can be regarded as the 3D model of the audience.

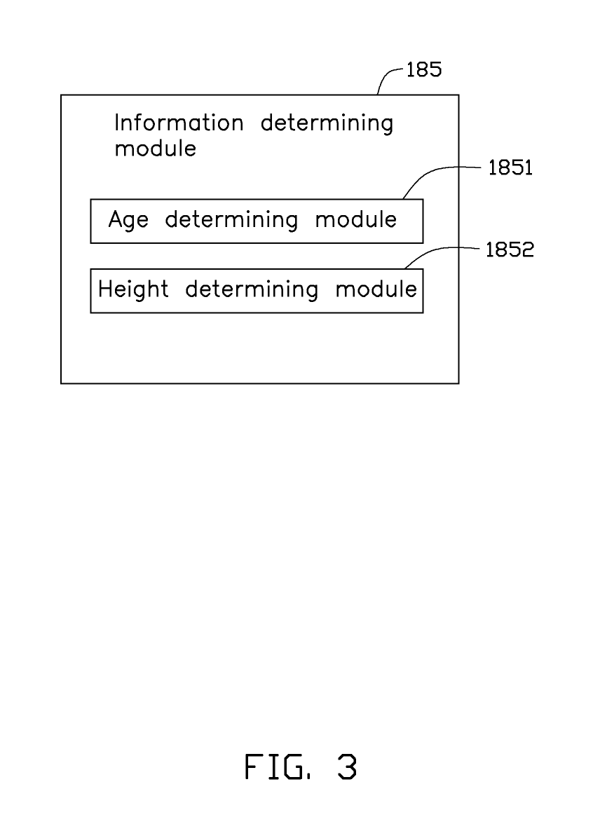

The information determining module 185 obtains demographic information of the audience according to the 3D model of the audience, such as ages and heights of the audience. Referring to FIG. 3, the information determining module 185 includes an age determining module 1851 and a height determining module 1852. In other embodiments, the information determining module 185 may include other modules, such as a gender determining module.

The age determining module 1851 obtains the ages of the audience according to the 3D model of the audience. It is noteworthy that the age determining module 1851 uses facial recognition technology to determine the ages of the audience according to the 3D model of the audience. For example, the age determining module 1851 can compare the 3D model from the 3D model building module 182 with a plurality of 3D models stored in advance to obtain the ages of the audience.

The height determining module 1852 obtains the heights of the audience according to the 3D model of the audience. It is noteworthy that the height determining module 1852 uses well known technology to determine the heights of the audience according to the 3D model of the audience. For example, the height determining module 1852 can calculate a distance between the audience and the electronic billboard 10, and heights of the 3D model from the 3D model building module 182, to obtain the heights of the audience.

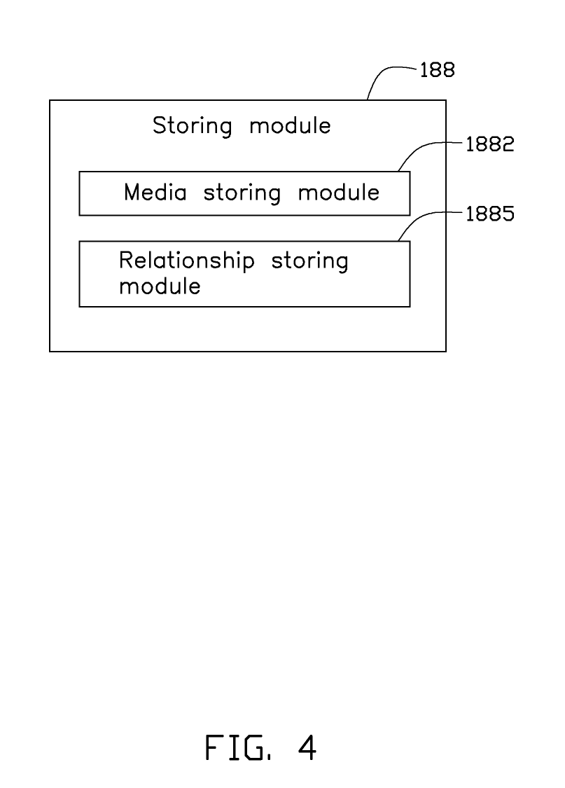

Referring to FIG. 4, the storing module 188 includes a media storing module 1882 and a relationship storing module 1885.

The media storing module 1882 stores a plurality of different media contents, such as advertisements for toys, height increasing shoes etc.

The relationship storing module 1885 stores a plurality of relationships between the audiences with different information and the different media content. For example, advertisements for toys may correspond to children audiences. Advertisements for height increasing shoes may correspond to audiences whose heights are lower than 150 centimeters (cm).

The controlling module 186 selects the media content according to the demographic information about the audiences, and transmits the selected media content to the electronic billboard 10. The electronic billboard 10 displays the media content stored in the media storing module 1882 according to the control module 186. For example, if audiences are children, media content selected are about toys. If audiences are lower than 150 cm, media content selected are about height increasing shoes.

In the embodiment described above, if the TOF camera 12 captures more than one audiences, the controlling module 186 selects the media content according to a more general demographic information about the audience.

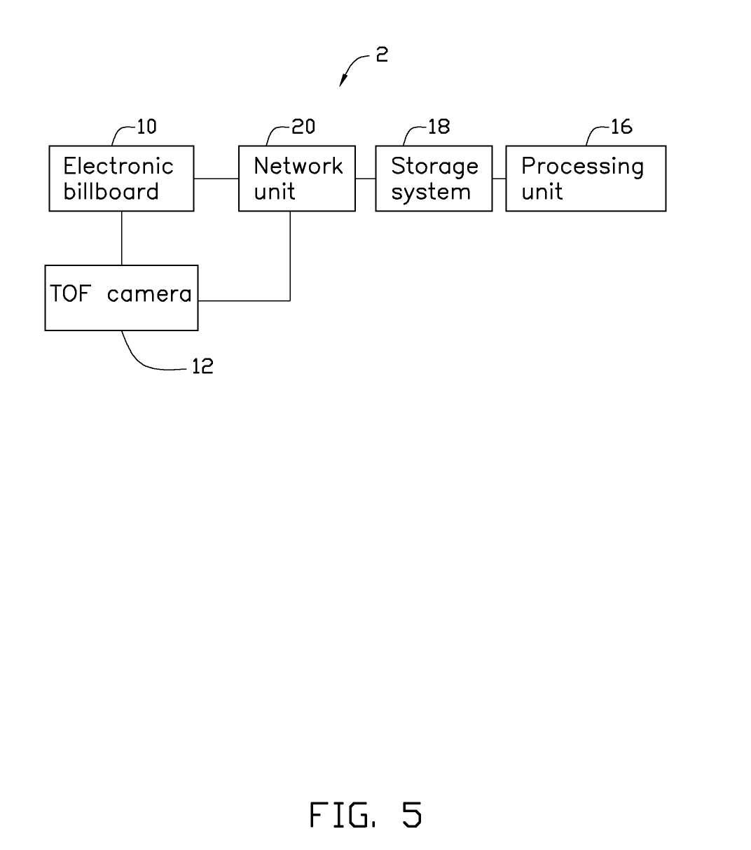

Referring to FIG. 5, a second embodiment of a media displaying system 2 includes a network unit 20, an electronic billboard 10, a time-of-flight (TOF) camera 12, a processing unit 16, and a storage system 18. The electronic billboard 10, the TOF camera 12, the processing unit 16, and the storage system 18 are the same as the first embodiment. The network unit 20 is operable to transmit images between the storage system 18 and the TOF camera 12, and transmit media content between the storage system 18 and the electronic billboard 10.

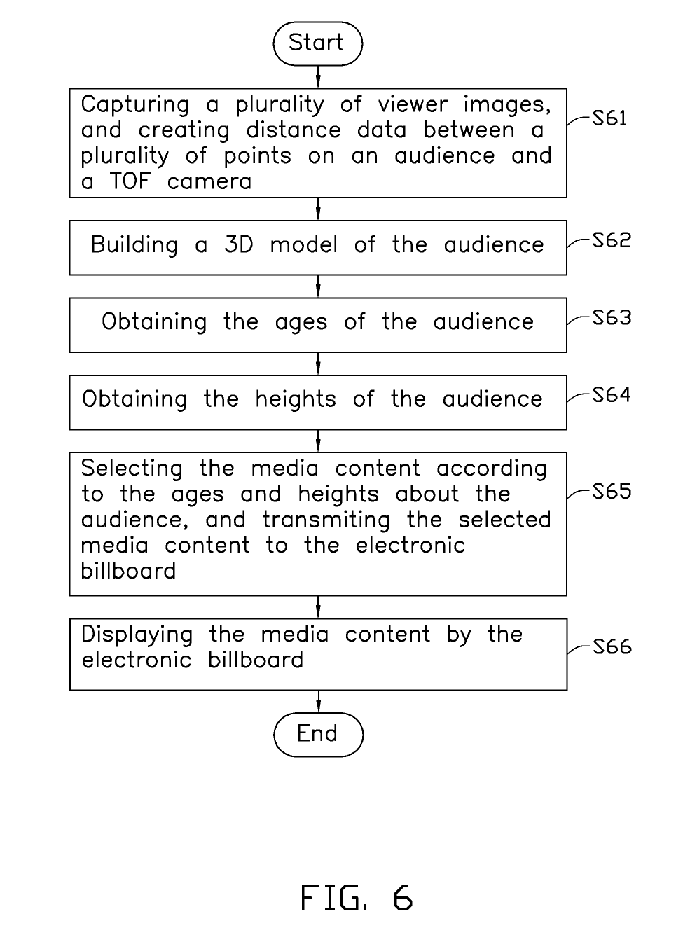

Referring to FIG. 6, an exemplary embodiment of a media displaying method includes the following steps.

In step S61, the TOF camera 12 captures a plurality of viewer images, and creates distance data between every point on the audience and the TOF camera 12. The distance data can be obtained according to time differences between sending and receiving the electrical signals of the TOF camera 12.

In step S62, the 3D model building module 182 builds a 3D model of the audience according to the images of the audience who is viewing the electronic billboard 10 and the distance data between every point of the audience and the TOF camera 12. A curved surface can be regarded as the 3D model of the audience.

In step S63, the age determining module 1851 obtains the ages of the audience according to the 3D model of the audience.

In step S64, the height determining module 1852 obtains the heights of the audience according to the 3D model of the audience.

In step S65, the controlling module 186 selects the media content according to the ages and heights about the audiences, and transmits the selected media content to the electronic billboard 10.

In step S66, the electronic billboard 10 displays the media content in the media storing module 1882 according to the controlling module 186.

The foregoing description of the exemplary embodiments of the disclosure have been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A media displaying system comprising:
a time-of-flight (TOF) camera to capture a plurality of audience images and obtain distance data between a plurality of points of the audience and the TOF camera;
a processing unit;
a storage system connected to the processing unit and storing a plurality of programs to be executed by the processing unit, wherein the storage system comprises:
a three dimension (3D) building module to build a 3D model of each audience according to the image of the audience and the distance data between the plurality of points of the audience and the TOF camera;
an information determining module to obtain demographic information of the audience according to the 3D model of the audience;
a storing module to store a plurality of different media content and a plurality of relationships between the audience with different demographic information and the different media content; and
a controlling module to select the media content according to the demographic information about the audience; and
a displaying unit connected to the storage system to display the selected media content.

2. The media displaying system of claim 1, wherein the 3D model building module obtains a curved surface according to the distance data between the plurality of points of the audience and the TOF camera, to obtain the 3D model of the audience.

3. The media displaying system of claim 1, wherein the information determining module comprises an age determining module to obtain ages of the audiences according to the 3D models of the audiences.

4. The media displaying system of claim 1, wherein the information determining module comprises a height determining module to obtain heights of the audiences according to the 3D models of the audiences.

5. The media displaying system of claim 1, further comprising a network unit to transmit the images between the storage system and the TOF camera, and transmit media contents between the storage system and the displaying unit.

6. The media displaying system of claim 1, wherein the displaying unit is an electronic billboard.

7. A media displaying method comprising:
capturing a plurality of audience images, and obtaining distance data between a plurality of points of the audience and a time-of-flight (TOF) camera by the TOF camera;
building a three dimension (3D) model of the audience according to the image of each audience and the distance data between the plurality of points of the audience and the TOF camera;
obtaining demographic information of the audience according to the 3D model of the audience;
selecting media content according to the demographic information about the audience; and
displaying the selected media content by a displaying unit.

8. The media displaying method of claim 7, wherein a curved surface is obtained according to the distance data between the plurality of points of each audience and the TOF camera, to obtain the 3D model of the audience.

9. The media displaying method of claim 7, wherein the demographic information of the audience comprises ages of the audience.

10. The media displaying method of claim 7, wherein the demographic information of the audience comprises heights of the audience.

11. The media displaying method of claim 7, wherein the displaying unit is an electronic billboard.
